(19) United States
(12) Patent Application Publication
(10) Pub. No.: US 2019/0251482 A1
(43) Pub. Date: Aug. 15, 2019

(54) Ticketing System and Method Thereof

(71) Applicant: Aaron Zhang, Allendale, NJ (US)

(72) Inventor: Aaron Zhang, Allendale, NJ (US)

(21) Appl. No.: 15/896,876

(22) Filed: Feb. 14, 2018

(51) Int. Cl. G06Q 10/02; G06Q 20/10; G06Q 30/04; G06Q 30/06

(52) U.S. Cl. CPC G06Q 10/02; G06Q 30/06; G06Q 30/04; G06Q 20/102

(57) ABSTRACT

A ticketing method includes the steps of producing tickets based on requirements, docketing information concerning the tickets in a server, docketing at least one entity's record on the server, distributing a previously determined amount of tickets and recording ticket information related to the distributed tickets to the at least one entity, activating at least one distributed ticket after logging on the server by the at least one entity, fulfilling previously determined payment rules after customer acquiring the activated at least one ticket, and confirming effectiveness of the acquired at least one ticket after the server receives fulfillment confirmation signal is received.

### TECHNICAL FIELD

The present disclosure relates to a ticketing system for selling tickets online in an interactive manner, and more particularly, to a ticketing method using the same ticketing system.

### DISCUSSION OF THE BACKGROUND

Currently, there are problems in tickets for nightlife events, sporting events, theater shows, comedy shows, lotteries and even transportation, tourist sites . . . etc., such as:

1). Customers have to go to ticket booths or visit public online links to purchase tickets of what they want and pay on the spot, which lacks flexibility and options for the customers. Customers may also buy tickets on the streets from ticket scalpers and/or authorized resellers, promoters. More importantly, sometimes, buying tickets from the streets is dangerous and there is no guarantee to the customers.

2). Lack of knowledge of the ticket related information might be the biggest concern for customers. As a result, customers without detailed information concerning the events do not have interests to know any further information of the ticket source. Furthermore, when the tickets are bought from the streets, the ticket legitimacy is not guaranteed so that customers holding the tickets and trying to get into whatever the events are would be blocked by the doormen.

3). Even with the advance of online ticketing systems, there is a lack of interactive actions between the ticket selling party and the customers, as well as a lack of real-time issue-solving capabilities and customers' account management system. All of which may contribute to missed revenue in ticketing. Also, lack of clarity of ticketing operation may be a loophole for unauthorized personnel as they might take chances to raise the ticket price and make their own money.

Furthermore, the current method of on-the-ground ticketing (i.e. sales of printed tickets) and promotion does not capture customer data or consolidate sales records as transactions are dealt in cash or peer-to-peer digital payments.

The above discussions limit service efficiency and quality for ticketing system nowadays.

For the purpose of solving the above problems, the preferred embodiment of the present invention provides a ticketing system as well as a ticketing method.

### SUMMARY OF THE INVENTION

In one aspect of the preferred embodiment of the present invention, there is provided with a ticketing method comprising the steps of:

producing tickets based on requirements;

docketing information concerning the tickets in a server;

docketing at least one salesperson record on the server;

distributing a previously determined amount of tickets and recording ticket information related to the distributed tickets to the at least one salesperson;

activating at least one distributed ticket after logging on the server by salesperson;

paying fee to the at least one salesperson according to previously determined rules after customer acquiring the activated at least one ticket;

confirming effectiveness of the acquired at least one ticket after the server receives payment confirmation signal is received.

In another aspect of the preferred embodiment of the present invention, the ticket producing step further comprises making physical tickets with barcode and/or code printed thereon.

In another aspect of the preferred embodiment of the present invention, the ticket producing step further comprises making electronic tickets respectively having identification information embedded therein.

In another aspect of the preferred embodiment of the present invention, the ticket information includes ticket ID, price information, number of person(s) corresponding to the price information and payment rules.

In another aspect of the preferred embodiment of the present invention, the activation step further comprises activating the at least one ticket after editing the ticket information, wherein the edited information includes event information corresponding to the at least one ticket, price information and number of person corresponding to the payment.

In another aspect of the preferred embodiment of the present invention, the previously determined payment rules include fluctuation of fee in accordance with time lapsed and/or deactivation of the at least one distributed ticket after a previously determined time period.

In another aspect of the preferred embodiment of the present invention, wherein the payment step further includes acquiring and storing customer's personal information.

In another aspect of the preferred embodiment of the present invention, the confirmation step further includes issuing the at least one ticket and issuing electronic invoice to customer.

In another aspect of the preferred embodiment of the present invention further has examining the at least one ticket after the server receives a ticket examining command and sends feedback.

In another aspect of the preferred embodiment of the present invention further has inquiring the docked record after the server receives a ticket inquiring command.

In another aspect of the preferred embodiment of the present invention, a system is provided to have at least one server connected to a host terminal, a point of sale device and a customer's terminal, wherein the server further has a first memory module to docket ticket information; a second memory module to record salesperson's information; a third memory module to distribute the previously determined amount of tickets to each salesperson and record information corresponding to the salesperson and the distributed tickets; a ticket sale module having an activation module to receive an activation command from the salesperson and activate ticket sold after agreement between the salesperson and the customer is established; a payment module to receive a payment signal from the customer and ensure the payment signal corresponds to the payment rules.

In another aspect of the preferred embodiment of the present invention, the server further has a first receiving module to receive a request command from the host terminal to issue the at least one ticket.

In another aspect of the preferred embodiment of the present invention, the server further has a sending module to provide the electronic invoice to the customer terminal after the payment module ensures effectiveness of payment.

In another aspect of the preferred embodiment of the present invention, the system further has a ticket examining module to receive a ticket examining command and send feedback.

In another aspect of the preferred embodiment of the present invention, the server is connected to a ticket examining terminal via internet so that the ticket examining module receives the ticket examining command from the ticket examining terminal.

In another aspect of the preferred embodiment of the present invention, the server of the system further has a inquiring module to receive a inquiry command and provide inquiry result including recorded and docketed information in the first memory module, the second memory module and the third memory module.

In another aspect of the preferred embodiment of the present invention, the first memory of the system further is applied to activate the at least one ticket, record event information corresponding to the at least one ticket, price of the at least one ticket, number of persons corresponding to the at least one ticket, and activation time and location.

The advantage of the present invention is that the system divides ticket sale into activation and payment. The customer is able to activate the ticket from the salesperson to have a temporary use of the ticket and complete the payment within a previously determined time period to avoid ticket to become invalid. With the payment rules so defined, the ticket price is fluctuated as time goes, i.e., appreciation or devaluation, so as to encourage the customer to complete the payment in time when the ticket price is appropriate. Both the appreciation and devaluation information are able to be inquired online by the customer to allow the customer to have all the necessary information in real-time and to enhance interaction between the server and the customer. Furthermore, when logged on, the server will automatically collect customer's information to establish customers' management database.

With the ticketing system and the method thereof, problems related to customer's lack of option and time to consider are solved. Also, customer's the initiative during the entire purchase is enhanced and the possibility of closing the transaction is increased.

### BRIEF DESCRIPTION OF THE DRAWINGS

A more complete understanding of the present disclosure may be derived by referring to the detailed description and claims. The disclosure should also be understood to be connected to the figures' reference numbers, which refer to similar elements throughout the description, and:

FIG. 1 is a block diagram of the first preferred embodiment of the ticketing method of the present invention;

FIG. 2 is a flowchart showing the first preferred embodiment of the ticketing method of the present invention;

FIG. 3 is a block diagram showing the first preferred embodiment of the ticketing system of the present invention;

FIG. 4 is still a block diagram showing the second preferred embodiment of the ticketing system of the present invention; and

FIG. 5 is a flowchart showing the second preferred embodiment for the ticket examination process used in the ticketing system of the present invention.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limited to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

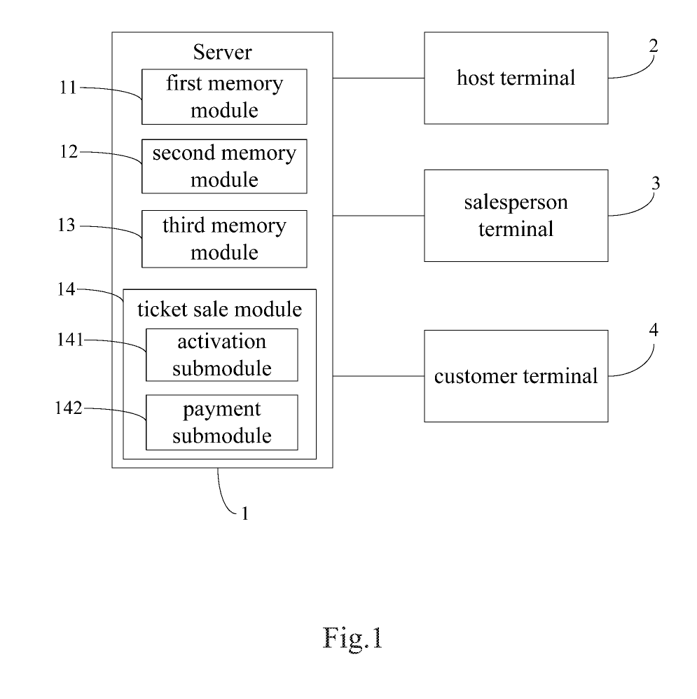

Referring to FIG. 1, the ticketing system of the preferred embodiment of the present invention includes at least one server 1 connected to a host terminal 2 via internet, a salesperson terminal 3 and a customer terminal 4. The server 1 is used for general management of ticket sale and docketing information thereof. The host terminal 2, the salesperson terminal 3 and the customer terminal 4 may be a computer terminal, a smart mobile terminal, e.g., smartphone, laptop computer, a laptop, POS (point of sale) device and/or onboard computer.

The server 1 further has a first memory module 11, a second memory module 12, a third memory module 13 and a ticket sale module 14 provided further with an activation submodule 141 and a payment submodule 142.

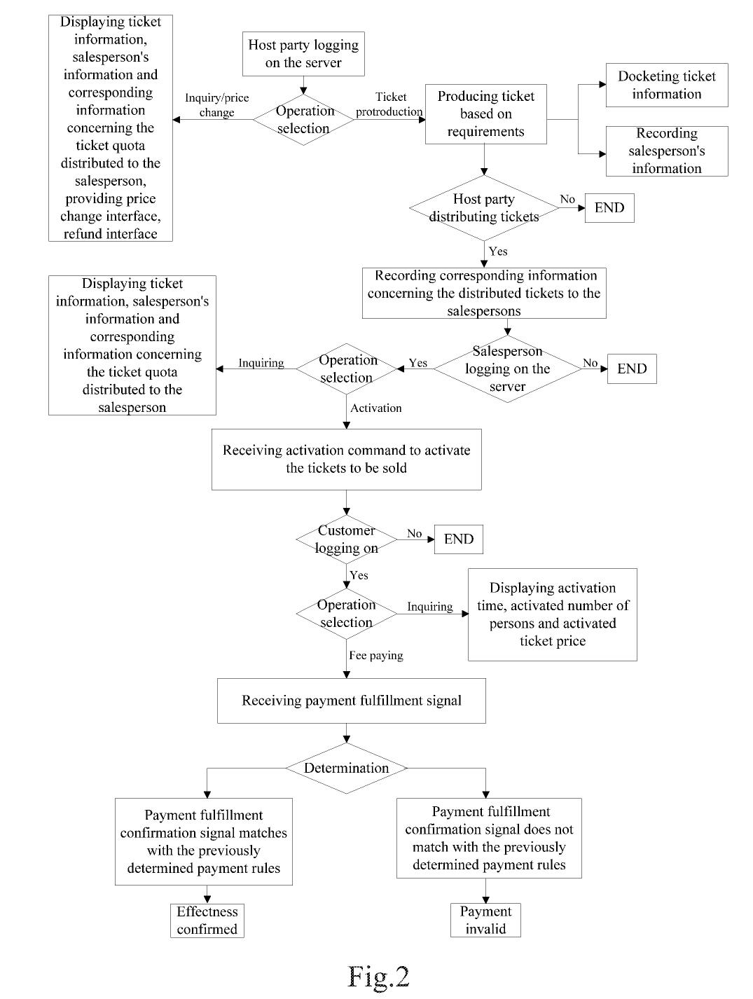

Specifically, combining the depiction of FIGS. 1 and 2, it is noted that when a host party is having an event or events, parties, competitions or any other activities, the hosting party needs to have all the requirements ready, which includes the basic ticket information in association with the event or events, such as the amount of ticket, price, the maximum ticket(s) to be activated, the maximum activation amount for each ticket and distributed quota of tickets for each salesperson (or maybe an entity). The basic ticket information may not represent the final activation information and is the preliminary modulation scope in the early stage of producing tickets, which does not even require the corresponding event information to the ticket so produced. The event information corresponding to the tickets sold, ticket prices, number of persons corresponding to the ticket sold may be given after the ticket is “activated”. Before the ticket is activated, there is no related event information, prices and number of persons corresponding to the ticket sold carried on the ticket. The host party is able to send commands to the server 1 via logging, or via any other know methods, onto the server 1.

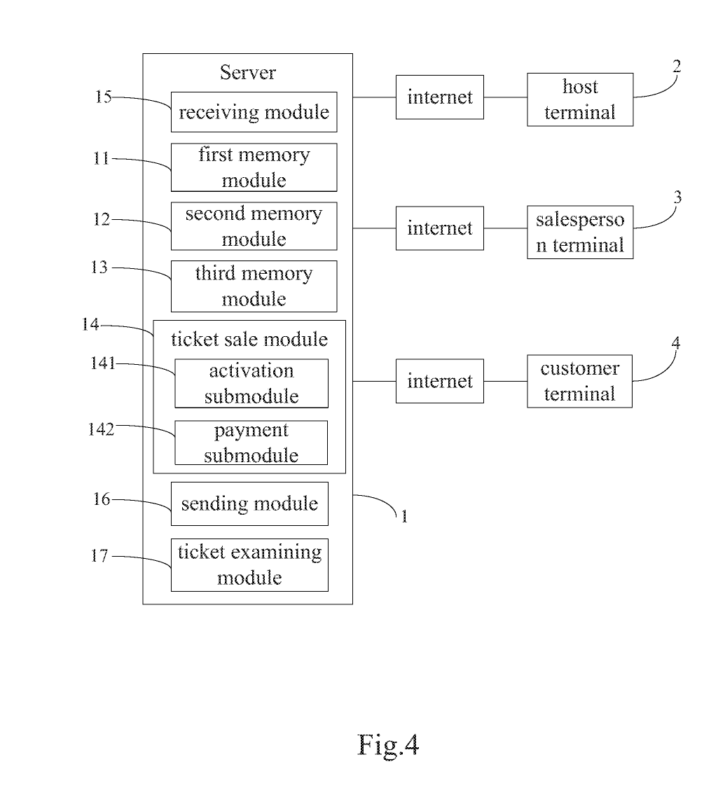

With reference to FIG. 4, the ticketing system of another preferred embodiment of the present invention further has a receiving module 15, compared to the system shown in FIG. 1, applied to the server logging method for the host party to send commands to the server 1.

The receiving module 15 is to receive commands from the host terminal 2 and produce tickets based on requirements. Whilst producing tickets, the receiving module 15 is able to select whether to produce physical tickets of electronic tickets. If the physical tickets are to be produced, barcode or code is printed onto the tickets and the so produced tickets will be sent to the host party. If the electronic tickets are to be produced, a unique identification information (ID information) is given to each of the produced tickets. When the electronic ticket(s) is used, either the barcode, code is scanned or the ID information is read to identify and for management of the uniqueness of the ticket.

The first memory module 11 of the server 1 records all the tickets produced and ticket related information, wherein the ticket related information at least includes ticket ID, prices, number of persons corresponding to the ticket and payment rules. The ticket related information may be provided by the host party directly or acquired after process by the server to the basic ticket information provided by the host party.

The host party is then able to distribute the tickets to salespersons respectively having a certain amount of tickets. The second memory module 12 of the server 1 records all the sale situation by the salesperson and the third memory module 13 records the ticket related information corresponding to the tickets distributed to the salesperson.

The first memory module 11, the second memory module 12 and the third memory module 13 may be three respectively memory chips or integrated into one memory chip.

With the provision of the sale module 14, the ticket sale is accomplished. The sale module 14 further has an activation submodule 141 responsible for activating the ticket sold and the payment submodule 142 responsible for the operation after the tickets is activated and sold.

The activation submodule 141 is to receive activation commands from the salesperson terminal and activate the tickets to be sold after initial sale agreement is accomplished. The activation submodule 141 is connected to the salesperson terminal 3 via internet.

The salesperson is able to log-on the server 1 via the salesperson terminal 3 and input at least one barcode or ID (the input may be accomplished via scanning or manual labor) of the tickets to activate the ticket(s) and the server 1 provides the activation interface. On the activation interface, the salesperson is able to choose an activated price for a ticket and a number of person(s) for the activated ticket(s), the number of persons sharing the same ticket, according to customer's requirements without exceeding the basic ticket information provided by the host party in the process of producing tickets. That is, the salesperson can only select activation information within a modulation scope to ensure the host party has full power over the general management of the tickets and to bestow a modulation power to the salesperson. In detail, if the customer wants to bring along more than one friend to participate the event, the salesperson may then select to activate on the activation interface a corresponding number of persons on the same ticket without the need of activating multiple tickets (if the tickets are physical tickets) and cutting down any necessary cost spent on the production of tickets. In the meantime, when the salesperson activates the ticket(s), the first memory module 11 of the server 1 automatically updates the ticket status from “to-be-sold” to “activated”. Also, the first memory module records event information corresponding to the activated ticket(s), the activated price, number of person(s) corresponding to the activated ticket(s), the activated time as well as the activated location. After the salesperson activated the ticket, the salesperson then hands over the tickets to the customer, if the ticket is a physical ticket. And if the ticket is an electronic ticket, the salesperson sends the electronic ticket to the customer through the email or any known electronic communication channels.

The payment submodule 142 is used to receive a payment confirmation information from the customer terminal 4 and to ensure the effectiveness of the ticket sold after the payment confirmation information matches with the previously determined payment rules. The payment submodule 142 is connected to the customer terminal 4 via internet.

The customer may use the customer terminal 4 to connect to the server 1 and the server 1 will provide the payment interface corresponding to the ticket sold so that the customer may fulfill the payment procedure. The payment interface may provide corresponding information concerning the related event, activating person, the activated number of persons, current price and previously determined payment rules. The current price is a price based from the activated price under the variations of the previously determined payment rules, which is the real price the customer may have at the moment. The current price may be higher or lower than or equal to the activated price according to the previously determined payment rules. The characteristic feature of the preferred embodiment of the present invention is that: the customer is able to select any timing for the payment without fulfilling the payment at the time the ticket is activated so that the customer has much more freedom of initiative for purchasing the ticket. Furthermore, the customer is able to purchase the ticket at the appropriate timing for the appropriate ticket price, which greatly increases the customer's interest for purchasing the ticket. Naturally, the customer may select fulfilling the payment at the time the ticket is activated to acquire the ownership of the ticket, which is the most bargain for the customer.

After the customer completed payment on the payment interface provided by the server 1, the payment interface will then generate a payment confirmation information and a server 1 receipt confirmation information. The payment confirmation information is then inquired to see if the payment is in compliance with the previously determined payment rules. If confirmed, the payment is deemed effective and the first memory module 11 of the server 1 changes the ticket status from “activated” to “effective”.

An example of the previously determined payment rules is given in the following.

As discussed, when the ticket is activated, the first memory module 11 o the server 1 simultaneously records the activation time as well as the activation price at the moment the ticket is activated, which are mostly associated with the payment rules.

### First Embodiment

The payment rules include: an amount of payment fluctuates along with time lapses, e.g., the amount of payment is equal to the activated price plus price fluctuation, in which, the activated price is the price in the server 1 when the ticket is activated and the fluctuation price is key to the change of the price. It may be a fixed amount or a variable.

Preferably, the fluctuation price is associated with the activated price, particularly, the fluctuation price might change within the previously determined price change rules after the ticket activation time. The price change rules further include the fluctuation price may remain unchanged, zero, or a fixed amount within a certain period of time after the activation time, which leads to the result that the actual price may be higher or lower than the activation price. After the certain period of time and, of course, after the activation time, the fluctuation price incrementally increases or decreases according to a previously determined increment, leading that the current actual price may be higher or lower than the activation price. For example, the certain period of time is set to be five (5) minutes and the increment is set to be two (2) dollars. Then, after the ticket is activated, the activated price remains unchanged within five minutes. If the payment is not made within the five-minute timeframe, the actual price for the same ticket increases to seven dollars.

### Another Embodiment

The payment rules include: when the payment is not made and exceeds the certain period of time, the activation is revoked or dismissed. For example, the timeframe is set to be two days and if the payment is not made within two days or the payment confirmation information is not made, activation to the ticket is dismissed automatically and the first memory module 11 of the server 11 automatically deletes the related information of that ticket. The ticket becomes invalid. Alternatively, the ticket status in the first memory module 11 may be changed from “activated” to “to-be-sold”. If the ticket is an electronic ticket, the necessary thing to be is to change the ticket basic information. If the ticket is a physical ticket, the physical ticket needs to be recycled or a duplicate is produced with the same barcode/code to replace the old one and a mark maybe provided to the invalid ticket to prevent unauthorized use.

The payment rules discussed above is only for an example and should not be deemed as a limitation to the scope of protection. The above two embodiments may be combined to such as: the amount of payment fluctuates as time lapses and if the payment is not made within a certain period of time, the ticket activation is dismissed. Different kinds of payments may be formed according to the scope of the preferred embodiment of the present invention. The preferred embodiment so provided presents two unique, yet separate steps, i.e., “activation” and “payment”. In the payment, a certain control steps may be made to appropriately change the ticket price to expediate the customer to complete the payment as well as fast release the previously occupied “opening” so as to fast track down a new customer and reactivate the ticket.

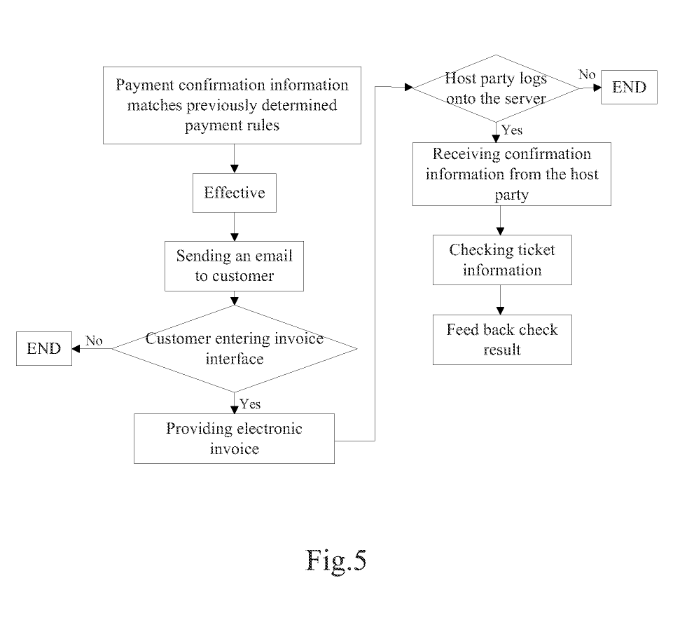

With reference to FIGS. 4 and 5, the ticketing system of the second preferred embodiment of the present invention further has a sending module 16 and a ticket examining module 17.

The sending module 16: when the ticket is confirmed valid by the payment submodule 142, the sending module 16 sends out an electronic invoice and is connected to the customer terminal 4 via a communication network.

Customer terminal 4 leaves customer's information, such as names, email account and address in the server 1 when logged thereon. The server 1 will then record and maintain these information (the information may be stored in the first memory module or a new memory module is established to store such information). After the payment is made, the customer terminal 4 sends a message to the email account left by the customer who will then proceed certain processes, e.g., using the link attached to the email or website, and is taken to the invoice interface provided by the server 1 to acquire electronic invoice(s). should the customer want to send the invoice to some of the persons sharing the same ticket, the customer may use the snapshot and send the picture to that person. Ticket sold has multiple numerals, characters and website provided thereon so the safety thereof is ensured.

Ticket examining module 17: the ticket examining module 17 is to receive from the host terminal 2 a confirmation command carrying an onsite ticket scanned information. After the server 1 receives the confirmation command, the basic ticket information is matched with the ticket basic information stored in the first memory module 11. If the two pieces of information match, including but not limited, if the current ticket status is changed to “effectiveness”, number of person activated, if there is someone who already entered the event and number of person who already entered, the ticket examining module 17 sends a feedback signal to the host terminal 2 and records the ticket examining result.

It is also possible to use the communication network to connect to the ticket examining terminal (not shown). The ticket examining terminal is used to replace the host terminal to specially send a confirmation command and receive a feedback signal so that the host and the ticket examining processes are separated to fit different occasions.

Specifically, on the day of event, the customer may carry the physical ticket (or electronic ticket) or the electronic invoice to the event site. Staff from the host or the ticket examining personnel scans the barcode or inputs the serial number on the ticket. The host terminal or the ticket examining terminal sends the scanned result to the server 1 which matches the received result with the information stored in the first memory module 11. After the ticket is proved to be authentic and the number of person(s) matches the activated number of persons, a feedback signal confirming the effectiveness of the ticket is sent to the host party. After the host party or the ticket examining party receives the feedback signal, the customer is allowed to enter the event. The server 1 automatically records the entrance information, e.g., five persons carrying the same ticket, the ticket may be required to scanned five times to record the number of persons entering the event.

In addition, due to the first memory module 11, the second memory module 12 and the third memory module 13 in the server 1, a large amount of date can be stored therein and the data includes ticket related information, salesperson related information, host party related information and even the customer related information. A large digital network may be built based on the data. In the meantime, a inquiry module (not shown) may be added to the ticketing system of the preferred embodiment of the present invention to receive a inquiry command After the ID of the person requesting the inquiry is confirmed, the inquiry result is read and organized from the corresponding memory module and presented onto the server interface or sent to the person requesting the inquiry directly. The requester may log on the server to acquire the requested information or via other communication networking to have the information, which is very user friendly and one of the characteristic of the preferred embodiment of the present invention. In the old days, it is impossible to gather customer's information if the host party only sells physical tickets, and is very inconvenient for data management and lack of interaction between the host party and the customer.

The salesperson may log on the server via the salesperson terminal to inquire on previous sale record and maintain customers' information to better present his/her performance to the host party, for example, the salesperson has 999 customers and yearly performance reaches $999 dollars. The salesperson may place a note on the salesperson terminal concerning the number of activated tickets as well as the customer's name alongside the activated tickets such that the salesperson may remind the customer to complete the payment and also use the note as a reminder as to how many customers have completed the payment and how many customers have not completed the payment.

With the ticketing system of the preferred embodiment of the present invention, problems like lack of selection and consideration time for the customer when purchasing the tickets are solved and may increase the customer's initiative in purchasing the ticket, which is beneficial to complete a deal between the salesperson and the customer. The biggest advantage of the ticketing system of the preferred embodiment of the present invention is that the system divides the ticket sale into “activation” and “payment”. The customer may complete the activation process from the salesperson via the customer terminal to have a temporary right of the activated ticket and then complete the payment process within a certain period of time to avoid the ticket to become abandoned or invalid in accordance with the previously determined payment rules. That is, the “activated” ticket price may fluctuate, devaluation or appreciation as time lapses so that the system or the salesperson may monitor or urge the customer to complete the payment in time. Again, naturally, the price fluctuation may be reviewed by the customer after logged onto the system server to allow the customer to keep track of the price fluctuation and therefore enhance interaction. In addition, while the customer logs onto the system server, the system may automatically collect customer's personal information in order to establish a customer database and strengthen management thereof.

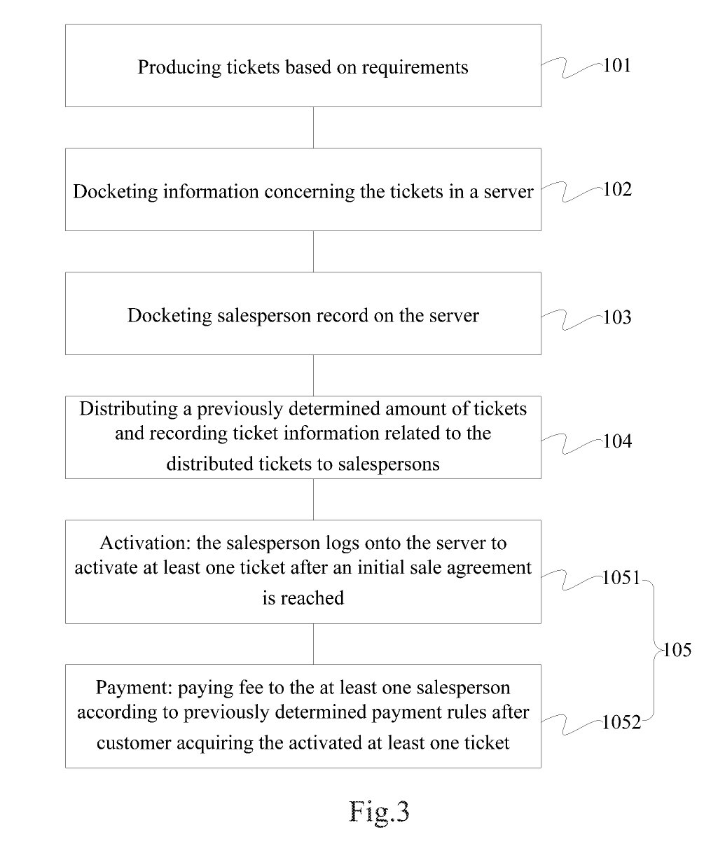

With reference to FIGS. 2 and 3, a further detailed description to the operation depicted in FIG. 1 of the ticketing system of the preferred embodiment of the present invention is provided.

As shown in FIG. 2, the ticketing method comprises:

101: producing tickets based on requirements;

102: docketing information concerning the tickets in a server;

103: docketing salesperson record on the server;

104: distributing a previously determined amount of tickets and recording ticket information related to the distributed tickets to salespersons;

105: activating at least one distributed ticket via following steps after logging on the server by at least one salesperson;
i. 1051: activation: the salesperson logs onto the server to activate at least one ticket after an initial sale agreement is reached;
ii. 1052: payment: paying fee to the at least one salesperson according to previously determined payment rules after customer acquiring the activated at least one ticket;

106: confirming effectiveness of the acquired at least one ticket after the server receives payment confirmation signal is received.

Preferably, in step 101, the ticket producing step further includes producing physical at least one ticket with barcode and/or code provided onto the at least one ticket or producing at least one electronic ticket provided with identification information therewith.

Preferably, in step 102, the ticket information at least includes ticket ID information, price information, number of person corresponding to the at least one ticket and a previously determined payment rules.

Preferably, in step 105, the activation step further includes: the salesperson transmits an activation command to the server after logging onto the server and scanning the barcode or inputting the code.

Preferably, in step 105, the activation step further includes: after the ticket information is edited/compiled, the salesperson activates the at least one ticket.

Further, the edited/complied ticket information includes event information corresponding to the activated at least one ticket, price information corresponding to the activated at least one ticket and number of person(s) corresponding to the activated at least one ticket.

Preferably, in step 105, the activating at least one ticket step further includes recording event information corresponding to the at least one ticket; price information corresponding to the at least one ticket; number of persons corresponding to the at least one ticket, activation time, activating person and activation location.

Preferably, in step 105, the payment rules include the fee paid fluctuates as time lapses and/or when the payment is not made within a previously determined period of time, the activated at least one ticket is revoked.

Further, in step 105, the payment step further includes acquiring and storing customer's information.

Furthermore, the ticketing method of the preferred embodiment of the present invention includes a inquiring step: according to the content of a inquiring command, the server, after receiving the inquiring command, displays the corresponding information, which may include ticket information, salesperson information, host information and even customer's information, it all depends on requester's needs. The requester may be the host, salesperson or the customer or any other authorized personnel. Authorization can be previously set to different kinds of personnel or groups of personnel.

Combining the embodiment discussed in FIG. 1-3, it is noted that when the host party is hosting an event and physical tickets are produced, the ticket sale operation is completed as follows.

The host party logs onto the server 1 via the host terminal 2 to send out request commands to produce X number physical tickets.

The server 1, based on the request from the host party, contacts contractors to print out X number physical tickets respectively having a unique barcode/code.

The server 1 contacts the host party to deliver the produced tickets to the host party and inputs all the barcodes/codes of the produced tickets to the host terminal 2 in cooperation with ticket price information, e.g., 200 tickets in total, 20 dollars/each, 400 tickets, 25 dollars/each . . . ) or each ticket bearing the same price. Also, payment rules to describe after how much time later after the ticket is activated the ticket price fluctuated, i.e., devaluation or appreciation are provided. Again, the payment rules also include the instruction about if the payment is not made within a previously determined period of time, the activated ticket is revoked or become invalid. For example, the ticket price remains the same within five minutes after activated and every five minutes the ticket price increases two dollars if the payment is still not made. If the payment is not made after two days of activation, the ticket is automatically revoked or dismissed.

The total sum of the ticket price may not be the same as that calculated by the host party. The host party may provide description in the request concerning the maximum number of the activated tickets (or how many people are allowed to participate the event), the number of being activated in each ticket price (the number of persons using that particular ticket price) and the quota distributed to each of the salesperson. That is, if 1000 physical tickets are provided/produced, not necessarily there would be 1000 customers buying the tickets as there might be a number of persons sharing the same ticket. The characteristic of the preferred embodiment of the present invention is that the actual ticket value is separated from the carrier of the physical tickets. The physical ticket functions as a medium for the customer to enter the system. After the customer logs onto the system via the physical ticket, the customer is able to select among appropriate ticket prices and number of tickets to make the ticket purchase much more user-friendly.

The server 1 may provide the maximum activated ticket number, number of persons corresponding to each ticket, activation quota for each salesperson, price information as well as payment rules provided by the host party and record them into ticket information corresponding to each of the ticket prices.

The host party distributes the received physical tickets to each of the salespersons to allow each of the salesperson to have such as 20, 50 or even 100 tickets. Alternatively, the host party may just send pictures of the barcode/code to the salespersons without the need of sending the physical tickets to the salespersons. After the server stores all the salespersons' information and the distribution of tickets to the salespersons, the server records information concerning each salesperson and the corresponding distributed tickets.

Each of the distributed tickets can be activated by the salespersons and purchased by the customers. The salespersons have no control over the ticket prices, any discount or engagement with cash. What is authorized to the salesperson is only the activation of the tickets and delivery of the activated tickets to the customers.

Preferably, a salesperson may have tickets of different ticket prices, e.g., 20 tickets/20 dollars each, 30 tickets/25 dollars each. The salesperson may log onto the server to inquiry on the price variation of the tickets the salespersons have so that they may options to select appropriate customers to promote the tickets to whoever in need.

Alternatively, each salesperson may have different quotas for different ticket prices, such as the salesperson may have 20 tickets each worth 20 dollars and 30 tickets each worth 25 dollars. In this situation, the salespersons need to separate these two stacks of tickets. The salespersons may log onto the server to activate the tickets in the ticket prices to allow the salespersons to have a certain authority to control the tickets.

After the salesperson log onto the server 1 via the salesperson terminal 3, the salesperson may inquire on the ticket information, such as the number of activated tickets, number of activated ticket prices, number of days need to activate as well as rankings of the salespersons in the sale performance.

The salesperson may activate the ticket after logging onto the server via scanning the barcode/code of a physical ticket (or picture thereof). The server may then provide an activation interface on which the salesperson may select among prices and number of persons (sharing the same ticket based on requirements) corresponding to the selected price.

After the salesperson's activation of the ticket, the server automatically updates the status of the ticket from “to-be-sold” to “activated”. Thereafter, the activation time, activation price and activation number of persons are recorded in the server.

If the payment rules provided by the host party regulates that every five minutes after activation, the ticket price increases two dollars, the ticket price goes up two dollars should the payment not be made within five minutes. If the payment rules also include that if the payment is not made within two days after activation, the activated ticket will become invalid and the status of that ticket is changed to “to-be-sold”. All the payment rules should be informed to the customer at the moment the ticket is activated and the salesperson advises the customer to fulfill the payment on the spot or complete the payment as soon as possible.

The customer may log onto the server via a customer terminal and the customer may visit a ticket interface via scanning the barcode/code or inputting the website address. After logging onto the ticket interface, the customer may select which function to operate, such as inquiry or payment. If inquiry function is selected, the ticket interface presents the content of the event, the activation time, the activation price and payment rules. For example, what is the nature of this event, who is the person activating the ticket, how much is the activation price and how much time remained before the ticket price goes up/down or become invalid. With all the information, the customer may have a clear understanding of the value of the ticket and a comprehensive knowledge of all the related information. However, the customer may only have the right to browse the information and do not have the authority to edit or modify any of the information.

Should the customer find the presented information satisfactory, the customer may enter the payment operation provided by the server. The payment page reveals the fee to be paid (which might be equal to, larger than or less than the activation price according to the payment rules). The customer may use the communication network to complete the payment. After the payment is completed, the designated communication network sends a notification indicating the completion of the payment. The server then changes the ticket status from “activated” to “effective”. The above description completes the ticket sale process.

With reference to FIGS. 4 and 5, the second embodiment of the ticketing method of the preferred embodiment of the present invention is shows and described as follows.

As shown in FIG. 5, based on the ticketing system depicted in FIG. 2 as the first preferred embodiment of the present invention, description concerning how the payment confirmation information matches the previously determined payment rules and how the effective and activated ticket is examined before entering the event is provided.

After the ticket becomes effective, the server 1 sends out an email notification to an email address left by the customer at the time when the customer logs onto the server 1 to proceed the payment for the purchase of the ticket. Inside the notification, a link is attached for the customer to connect to the link so that an invoice interface is provided to the customer. An electronic invoice is revealed to the customer and downloadable for proof of purchase. Should the customer want to send the electronic invoice to some other people sharing the same ticket, the customer may send a snapshot from the screen, wherein the activated ticket contains a website having multiple serial numbers and characters for its website address, which is hard to duplicate and has high safety level.

On entering the event, the customer may have the physical ticket or the electronic receipt for scanning by the personnel from the host party. The host party personnel may use such as cellphone, RFID reader or any other smart devices to scan the barcode/code or serial number printed on the ticket. The scanned result may then be sent to the server as a confirmation command After the confirmation command is received, the server 1 verify the content of the ticket information which may include whether the ticket status is changed to “effective”, number of activated person(s), if there is/are some other person already entered the event and number of person(s) already entered the event. After verification, the server 1 sends a confirmation signal as a feedback message to the host terminal and records the ticket examination result. After the host party receives the feedback message, the customer is allowed to enter the event and the server 1 automatically records entrance information such as five persons are shoring the same ticket and the ticket is scanned five times. The ticket confirmation and become effective process to function as a certificate for entrance is now completed.

Preferably, in combination of the depiction in FIG. 3, the host party, after logged onto the server 1, has the authority to change the ticket price to the ticket in the “to-be-sold” status, such as select new ticket price, class appreciation/depreciation, partially appreciation/depreciation, or dismiss some of the activated tickets to decrease circulation of the activated ticket in the market, modify the payment rules to control ticket sale situation, which normally is targeted to the “to-be-sold” or “invalid” ticket. To those “activated” and “effective” tickets, even the host party has not authority over them. If the customer wants to have a refund, the host party is able to operate the refund via the server, which is the same as changing ticket price.

The host party may log onto the server at any time and conduct an inquiry on the overall ticket sale status. The server responds to the host party's inquiry command and displays the ticket overall sale situation, the salespersons' information and salespersons' performance, such as number of tickets sold by each salesperson, number of tickets at what price, number of activated tickets which are not paid, activation time and number of tickets in the inventory.

The host party may add or delete salesperson via logging onto the server. Also, corresponding information concerning the distributed ticket quota as well as the salesperson's information may be modified by the host party via the same process.

The biggest characteristic of the ticketing system and the method thereof described in the preferred embodiment of the present invention divides the ticket sale into “activation” and “payment” two parts, which are separate from one another, however, a link therebetween still exists.

The advantages of dividing the ticket sale into “activation” and “payment” are as follows.

1. The customer may take away the ticket if a decision to purchase the ticket cannot be made on the spot. For example, the salesperson may talk to the customer that you can take away the ticket and make the payment within five minutes and still pay the same price. However, if the payment is not made within five minutes, an increase will be made to the ticket price and if the payment is not made within two days, the ticket is dismissed. Holding the mindset of automatic appreciation of the ticket price, the customer will be much inclined to make the payment. Of course, a devaluation is another option.

2. The entire ticketing system has a particular characteristic: the host party may distribute lots of tickets to the same salesperson, even though there are only ten seats in an event, the host party may distribute a hundred tickets to the salesperson. Wide-spreading the tickets may boost the ticket sale as well as speed, which is the same principle between the salesperson and the customer. That is, activating and purchase being separated allows the salesperson to be in touch with many more customer. For example, if ten tickets have been activated and three of the customers have not made the payment, the salesperson may dismiss the three tickets and search for different customer and reactivate the tickets, which increases the salesperson's work performance and ticket sale speed.

3. Trial period effect. If the ticket is brought back home, every time the customer sees the ticket triggers a reminder to purchase the ticket, which is more effective than there is none. As the ticket lies just in front of the customer and the customer, under this constant influence of reminding, may easily make the payment. Naturally, the salesperson may not bring out the phrase such as “you don't have to pay for the ticket now” to the customer on the spot, only when the customer spells out the words “let me think it over” or “I will let you know later”. The date on the ticket which is changeable is not the same as that of some ordinary shopping coupon, which is fixed and unchangeable. Also, the ticket information in the ticketing system may be updated any time and the deadline may be varied depending on the activation time, which is much more flexible. Therefore, it is appreciated that the ticketing system of the preferred embodiment of the present invention may not only be applied to ticket sale, it may also be applied to other fields, even though the above discussion focuses on ticket sale. What matters is the principle of the system so discussed therein.

4. When the customer is making the payment, the system will automatically store the customer's information to allow the host party to maintain and manage the customers and increase interaction therebetween.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A ticketing method comprising the steps of:
producing tickets based on requirements;
docketing information concerning the tickets in a server;
docketing at least one entity's record on the server;
distributing a previously determined amount of tickets and recording ticket information related to the distributed tickets to the at least one entity;
activating at least one distributed ticket after logging on the server by the at least one entity;
fulfilling previously determined payment rules after customer acquiring the activated at least one ticket; and
confirming effectiveness of the acquired at least one ticket after the server receives fulfillment confirmation signal is received.

2. The ticketing method as claimed in claim 1 further comprising a step of making physical tickets with barcode and/or code printed thereon.

3. The ticketing method as claimed in claim 1, wherein the ticket producing step further comprises a step of making electronic tickets respectively having identification information embedded therein.

4. The ticketing method as claimed in claim 1, wherein the ticket information includes ticket ID, price information, number of person(s) corresponding to the price information and payment rules.

5. The ticketing method as claimed in claim 1, wherein the activation step further comprises activating the at least one ticket after editing the ticket information,
wherein the edited information includes event information corresponding to the distributed at least one ticket, price information and number of person corresponding to the payment rules.

6. The ticketing method as claimed in claim 1, wherein payment rules include fluctuation of fee in accordance with time lapsed and/or deactivation of the at least one distributed at least one ticket after a previously determined time period.

7. The ticketing method as claimed in claim 1, wherein the payment step further includes acquiring and storing customer's information.

8. The ticketing method as claimed in claim 1, wherein the confirmation step further includes issuing the at least one ticket and issuing electronic invoice to the customer.

9. The ticketing method as claimed in claim 1 further comprising a step of examining the at least one distributed ticket after the server receives a ticket examining command and consequently sends feedback.

10. The ticketing method as claimed in claim 1 further comprising a step of inquiring the docked record after the server receives a ticket inquiring command.

11. In a ticketing system having at least one server connected to a host terminal, a salesperson terminal and a customer's terminal, characterized in that the server further has:
a first memory module to docket ticket information;
a second memory module to record an entity's information;
a third memory module to distribute a previously determined amount of tickets to each entity and record information corresponding to the entity and the distributed tickets; and
a ticket sale module having:
an activation module to receive an activation command from the entity terminal and activate ticket sold after agreement between the entity and the customer is established; and
a payment module to receive a payment signal from the customer terminal and ensure the payment signal corresponds to previously determined payment rules.

12. The system as claimed in claim 11, wherein the server further has a first receiving module to receive a request command from the host terminal to issue the at least one ticket.

13. The system as claimed in claim 11, wherein the server further has a sending module to provide the electronic invoice to the customer terminal after the payment module ensures effectiveness of payment.

14. The system as claimed in claim 11, wherein the server further has a ticket examining module to receive a ticket examining command and send feedback.

15. The system as claimed in claim 14, wherein the server is connected to a ticket examining terminal via internet so that the ticket examining module receives the ticket examining command from the ticket examining terminal.

16. The system as claimed in claim 11, wherein the server further has a inquiring module to receive an inquiry command and provide inquiry result including recorded and docketed information in the first memory module, the second memory module and the third memory module.

17. The system as claimed in claim 11, wherein the first memory module is to activate the at least one ticket, record event information corresponding to the at least one ticket, price of the at least one ticket, number of persons corresponding to the at least one ticket, and activation time and location.
